(19) United States
(12) Patent Application Publication
(10) Pub. No.: US 2006/0136679 A1
(43) Pub. Date: Jun. 22, 2006

(54) Protected processing apparatus, systems, and methods

(76) Inventor: Dennis M. O'Connor, Chandler, AZ (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/018,958

(22) Filed: Dec. 21, 2004

(51) Int. Cl. G06F 12/00

(52) U.S. Cl. 711/152

(57) ABSTRACT

An apparatus and a system, as well as a method and article, may operate to prohibit program execution from entering into a location of a physical memory partition from a location outside the physical memory partition if the physical memory partition location does not include an entry instruction.

### TECHNICAL FIELD

Various embodiments described herein relate to information processing generally, including apparatus, systems, and methods used to protect instructions and data during program execution.

### BACKGROUND INFORMATION

Some processor manufacturers leave the problem of protected physical memory access as an exercise for the system-on-chip designer to solve. For example, the number of protected domains that can be used to prevent non-secure code from accessing secure data stored in memory may be limited. Some schemes utilize special architecture attributes or virtual address partitions, introducing significant processing overhead. Other protection mechanisms may involve recoding non-kernel legacy code, including the operating system.

### DETAILED DESCRIPTION

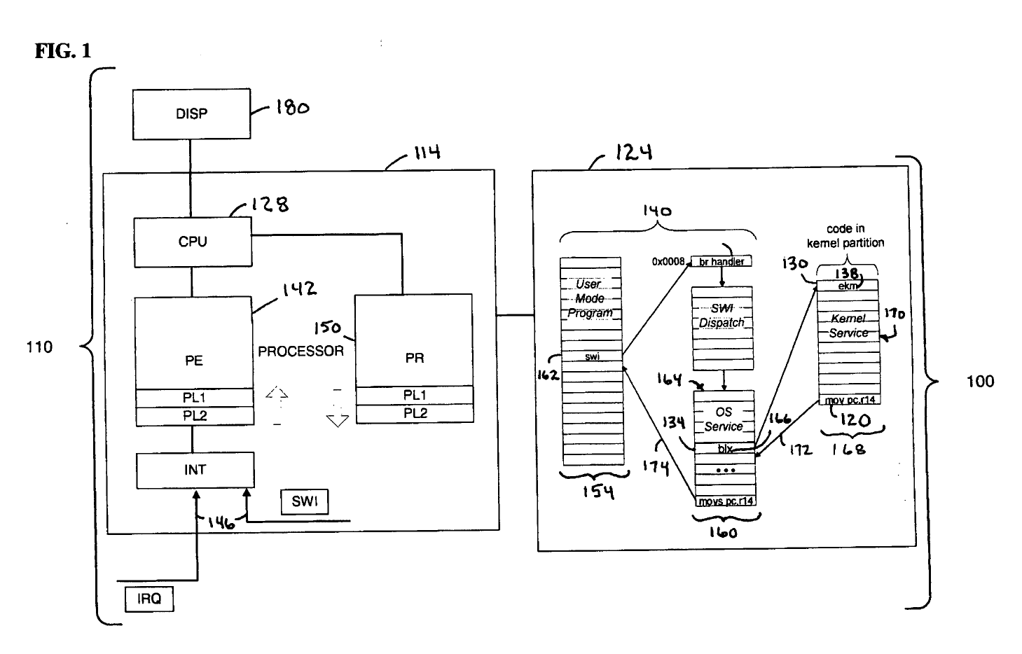

FIG. 1 is a block diagram of apparatus and systems according to various embodiments of the invention;

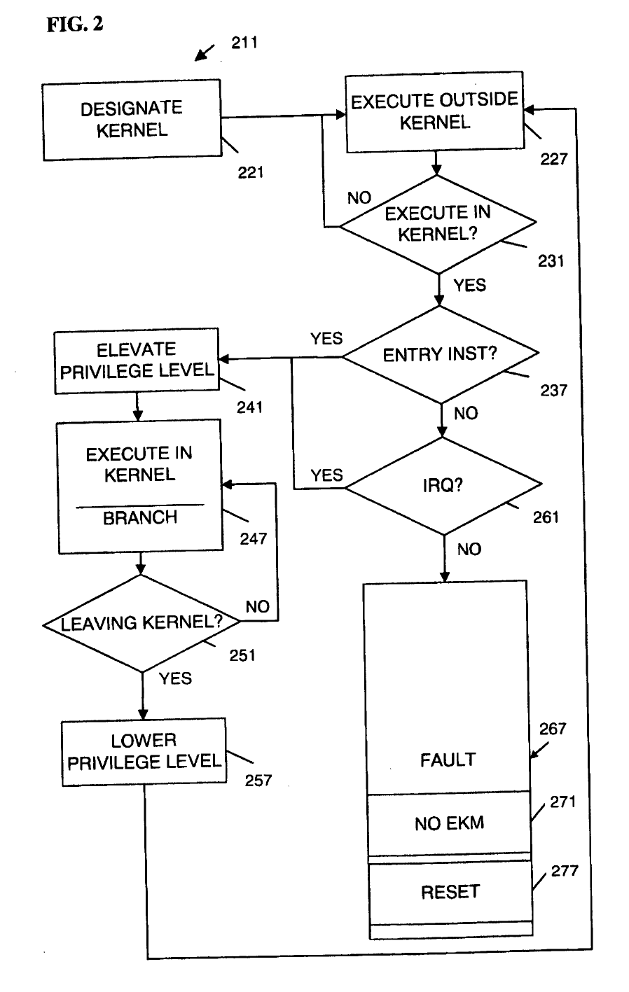

FIG. 2 is a flow diagram illustrating several methods according to various embodiments of the invention; and

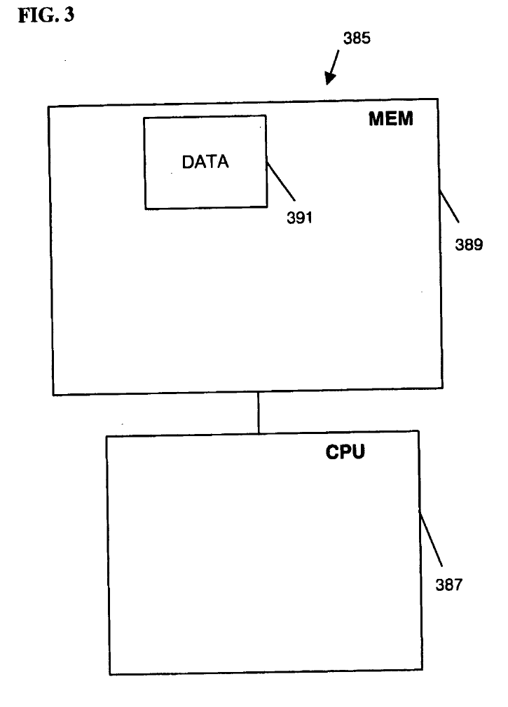

FIG. 3 is a block diagram of an article according to various embodiments of the invention.

### DETAILED DESCRIPTION

In some embodiments, a physical memory partition with special access privileges may be created. For example, processor physical address space may be arranged to include a designated physical memory partition, such as a kernel mode partition, having higher access privileges than other partitions. A dedicated entry instruction, denoted herein as the “enter kernel mode” (EKM) instruction, can be used for constructing guarded access points that permit entry into code residing in the physical memory partition.

The physical memory partition, which may comprise a kernel mode partition (or “kernel”), may be used to handle low-level dynamic resource management for processes running on a system, such as the allocation and sharing of memory, processors, and a variety of devices. Thus, a kernel mode partition may be implemented as a protected layer of code underlying processes accessed by a function call-type interface; data may be passed between a user process and the kernel on the stack, and programs may interact with the kernel through interprocess communication. An operating system may add functions to those provided by the kernel, such as services and administration tools for users, including a file system for managing disk space, quotas and user accounts, login sessions, etc.

Hardware, software, or firmware logic within a processor operating under various schemes disclosed herein may endow a physical memory partition, such as a kernel mode partition, with some or all of the following characteristics: (a) only instructions fetched from the kernel mode partition should have kernel mode access privileges, permitting such instructions to manipulate data in the kernel mode partition, as well as in less-privileged (e.g., non-kernel mode) partitions; (b) memory (including memory-mapped input-output (I/O) devices) within the kernel mode partition should be manipulated only by instructions having kernel mode access privileges; (c) the direct target of non-kernel mode code branching to, calling, or returning to kernel mode code should be an EKM instruction (a fault may be generated if this is not the case); (d) kernel code branching or proceeding sequentially to non-kernel code may cause a kernel mode exit—the first instruction of the non-kernel code to be executed may be any legal instruction; and (e) an exception or interrupt vector target may execute in kernel mode if it is in the kernel partition, and does not need to be an EKM instruction.

Throughout the remainder of this document, the term “kernel mode physical memory partition” is used for reasons of simplicity. However, the broader term “physical memory partition” may be substituted in its place in each case, as the concepts described herein may be applied to any physical memory partition, and not solely to physical memory partitions that comprise kernel mode partitions.

FIG. 1 is a block diagram of apparatus 100 and systems 110 according to various embodiments of the invention, each of which may operate in the manner described above. For example, an apparatus 100 may include a processor 114 to couple (directly or indirectly) to a memory structure 124. The processor 114 may be used to designate a kernel mode physical memory partition 120, perhaps included in the memory structure 124. The processor logic 128 may then operate to prohibit program execution from entering into a location 130 of the kernel mode physical memory partition from a location 134 outside the kernel mode physical memory partition 120 unless the kernel mode physical memory partition location 130 includes an entry instruction 138. In other words, if the kernel mode physical memory partition location 130 to which entry is sought does not contain an entry instruction 138 (e.g., an EKM instruction, or its equivalent), then program execution progress into the kernel mode physical memory partition 120 should not be permitted. A fault may be generated if such access is attempted.

The processor 114, coupled directly or indirectly to the memory structure 124 may be used to designate the kernel mode physical memory partition 120. In some embodiments, the processor may comprise an Intel®V XScale® processor. The kernel mode physical memory partition 120 may be statically or dynamically designated, and need not be contiguous. The memory structure 124 may include one or more memories 140 having a non-kernel mode physical memory partition.

In some embodiments, the apparatus 100 may include a privilege elevation module 142 to elevate a current privilege level PL2 to a privilege level PL1 associated with the kernel mode physical memory partition, responsive to executing the entry instruction 138, or accessing or entering the kernel mode physical memory partition 120. If the privilege level is not elevated to the privilege level PL1 associated with the kernel mode physical memory partition, then further execution may be prohibited.

The apparatus 100 may include an interrupt module 144 to couple to the processor 114 (or included in the processor 114) to receive an interrupt 146. Thus, in some embodiments, the privilege elevation module 142 may also operate to elevate a current privilege level PL2 to a privilege level PL1 associated with the kernel mode physical memory partition, responsive to receiving an interrupt 146 (assuming execution is to be continued in the kernel mode physical memory partition 120). The interrupt may comprise a software interrupt SWI, or a hardware interrupt, such as the hardware interrupt IRQ.

With respect to processing interrupts, it should be noted that the processor 114 may operate so that an entry instruction 138 is understood by various elements, such as the privilege elevation module 142, to be implicitly present at the location 130 if branching to that location 130 occurs as a result of receiving an interrupt 146. This mode of operation, where program execution progresses from outside the kernel mode physical memory partition 120 to inside the kernel mode physical memory partition 120 upon receipt of an interrupt 146, may be considered an alternative to explicitly placing the entry instruction 138 at the location 130. Implicit placement of the entry instruction 130 in this manner does not defeat the security obtained by virtue of the various embodiments discussed herein because execution of the kernel code 170 in this instance can only be initiated by virtue of a hardware or software interrupt, and not via regular coded instructions.

In some embodiments, the apparatus 100 may include a privilege reduction module 150 to reduce a current privilege level PL1 to a lower privilege level PL2, the lower privilege level PL2 being lower than the privilege level PL1 associated with the kernel mode physical memory partition. This activity may occur responsive to program execution leaving, or continuing outside, the kernel mode physical memory partition 120.

As an implementation example, consider user mode code 154 and operating system (OS) code 160 running on a processor 114, such as an Intel® XScale® processor. Operations can proceed in the usual fashion, with the user mode code 154 executing instructions until it reaches a software interrupt 162 to access OS services 164. Calls 166 to kernel mode services 168 should require no modification to the calling code; the usual branch-and-link operation may be performed. Kernel mode services 168 code should have an entry instruction 138 placed at every allowed entry point, so that broken or malicious code is not able to enter the kernel code 170 at an arbitrary point, bypassing parameter or other validation code. Further changes to code used in the kernel mode physical memory partition 120 should be unnecessary. Returns 172 from kernel mode program execution are accomplished in the usual fashion, similar to or identical that used to execute a return 174 from non-kernel partitions.

Many other embodiments may be realized. For example, a system 110 may include an apparatus 100, similar to or identical to that previously described, as well as a display 180 to couple to the processor 114. The display 180 may comprise a solid state display (e.g., a simple liquid crystal display, a flat panel display, etc.), a cathode-ray tube display, or a holographic display, among others. As described previously, the memory structure 124 may include a kernel mode physical memory partition 120 designated by the processor 114 so as to prohibit program execution from entering into a location 130 of the kernel mode physical memory partition 120 from a location 134 outside the kernel mode physical memory partition 120 unless kernel mode physical memory partition location 130 includes an entry instruction 138, such as an EKM instruction. As is the case with the apparatus 100, the memory structure 124 may include any number of kernel mode physical memory partitions 120. Each kernel mode physical memory partition 120 may include a separate privilege level, which may be the same as, or different than those privilege levels associated with other kernel mode physical memory partitions 120.

The apparatus 100; systems 110; processor 114; kernel mode physical memory partition 120; memory structure 124; processor logic 128; location 130, 134; entry instruction 138; memories 140; privilege elevation module 142; interrupt module 144; interrupts 146, IRQ, SWI; privilege reduction module 150; user mode code 154; OS code 160; software interrupts 162; OS services 164; calls 166; kernel mode services 168; kernel code 170; returns 172, 174; display 180; and privilege levels PL1, PL2 may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100 and systems 110, and as appropriate for particular implementations of various embodiments of the invention.

It should also be understood that the apparatus and systems of various embodiments can be used in applications other than for processing entry instructions in a kernel memory partition, and thus various embodiments are not to be so limited. The illustrations of apparatus 100 and systems 110 are intended to provide a general understanding of the structure of various embodiments, and they are not intended to serve as a complete description of all the elements and features of apparatus and systems that might make use of the structures described herein.

Applications that may include the novel apparatus and systems of various embodiments include electronic circuitry used in high-speed computers, communication and signal processing circuitry, modems, processor modules, embedded processors, data switches, and application-specific modules, including multilayer, multi-chip modules. Such apparatus and systems may further be included as sub-components within a variety of electronic systems, such as televisions, cellular telephones, personal computers, personal digital assistants (PDAs), workstations, radios, video players, vehicles, and others.

Some embodiments include a variety of methods. For example, FIG. 2 is a flow chart illustrating several methods according to various embodiments of the invention. In some embodiments, a method 211 may begin with designating a kernel mode physical memory partition at block 221. The method may continue with executing code outside of the kernel mode physical memory partition at block 227. If the next instruction to be executed (or data to be accessed) is not in the kernel mode physical memory partition, as determined at block 231, then execution may continue outside of the kernel mode physical memory partition at block 227.

If the next instruction to be executed is located in the kernel mode physical memory partition, then a determination is made as to whether the next instruction is an entry instruction (e.g., an EKM instruction) at block 237. If so, then the method 211 may include elevating a current privilege level to a privilege level associated with the kernel mode physical memory partition, responsive to entering the kernel mode physical memory partition, and executing the entry instruction, at block 241.

The method may continue from block 241 with executing code within the kernel mode physical memory partition at block 247. For example, the method 211 may include permitting access by code included in the kernel mode physical memory partition to any location in the kernel mode physical memory partition, as well as permitting access to any memory location in a computer (including the kernel mode physical memory partition) by code included in the kernel mode physical memory partition. In some embodiments, the method 211 may include permitting access by code included in the kernel mode physical memory partition to a memory location included in another physical memory partition, perhaps located in the same computer. In some cases, the other physical memory partition may be associated with a privilege level equal to or lower than the privilege level associated with the kernel mode physical memory partition.

As execution continues inside the kernel mode physical memory partition, a determination may be made as to whether the next instruction to be executed will result in leaving the kernel mode physical memory partition at block 251. If not, then execution may continue inside the kernel mode physical memory partition at block 247. If so, then the method 211 may continue with reducing the current privilege level to a lower privilege level than the privilege level associated with the kernel mode physical memory partition, responsive to program execution leaving, or continuing outside, the kernel mode physical memory partition at block 257. Program execution may then continue outside of the kernel mode physical memory partition at block 227.

If the determination made at block 237 indicates that the next instruction to be executed is in the kernel mode physical memory partition but not an entry instruction, then a determination may be made as to whether an interrupt has been received at block 261. If so, then execution may continue at block 241 with elevating the current privilege level to a privilege level associated with the kernel mode physical memory partition responsive to receiving the interrupt. Thus, the method 211 may include elevating the current privilege level to a privilege level associated with the kernel mode physical memory partition at block 241 by activating a hardware mechanism responsive to interrupting the program execution outside the kernel mode physical memory partition at a lower privilege level than the privilege level associated with the kernel mode physical memory partition. The method 211 may further include branching to an interrupt destination location in the kernel mode physical memory partition at block 247. For example, branching to an interrupt destination location in a kernel mode physical memory partition may occur by activating a hardware mechanism in response to interrupting the program execution outside the kernel mode physical memory partition, and altering the current privilege level to the privilege level associated with the kernel mode physical memory partition.

If the determination as to whether an interrupt has been received at block 261 yields a negative result, then further program execution may be prohibited from entering into a location of a kernel mode physical memory partition at block 267. That is, the method 211 may include prohibiting program execution from a location outside the kernel mode physical memory partition into a location of the kernel mode physical memory partition at block 267 unless the location of the kernel mode physical memory partition includes an entry instruction. The method 211 may also include, at block 267, prohibiting branching to an interrupt destination location when initiated via executing an instruction not associated with a software or hardware interrupt, for example.

In some embodiments, the method 211 may include, at block 271, generating a fault responsive to detecting an attempt to continue program execution into a location of the kernel mode physical memory partition, where the location does not include an entry instruction. The method 211 may also include resetting a computer including a kernel mode physical memory partition responsive to detecting an attempt to continue the program execution into a location of the kernel mode physical memory partition that does not have an entry instruction at block 277. In some embodiments, a method 211 may include, at block 271, generating a fault responsive to detecting an attempt to execute an entry instruction when outside the kernel mode physical memory partition.

It should be noted that the methods described herein do not have to be executed in the order described, or in any particular order. Moreover, various activities described with respect to the methods identified herein can be executed in serial, parallel, simultaneous, or iterative fashion. For the purposes of this document, the terms “information” and “data” may be used interchangeably. Information, including parameters, commands, operands, and other data, including data in various formats (e.g., time division, multiple access) and of various types (e.g., binary, alphanumeric, audio, video), can be sent and received in the form of one or more carrier waves.

Upon reading and comprehending the content of this disclosure, one of ordinary skill in the art will understand the manner in which a software program can be launched from a computer-readable medium in a computer-based system to execute the functions defmed in the software program. One of ordinary skill in the art will further understand the various programming languages that may be employed to create one or more software programs designed to implement and perform the methods disclosed herein. The programs may be structured in an object-orientated format using an object-oriented language such as Java or C++. Alternatively, the programs can be structured in a procedure-orientated format using a procedural language, such as assembly or C. The software components may communicate using any of a number of mechanisms well-known to those skilled in the art, such as application program interfaces or inter-process communication techniques, including remote procedure calls. The teachings of various embodiments are not limited to any particular programming language or environment.

Thus, many embodiments may be realized, as shown in FIG. 3, which is a block diagram of an article 385 according to various embodiments, such as a computer, a memory system, a magnetic or optical disk, some other storage device, and/or any type of electronic device or system. The article 385 may comprise a processor 387 coupled to a machine-accessible medium such as a memory 389 (e.g., a memory including an electrical, optical, or electromagnetic conductor) having associated information 391 (e.g., computer program instructions, and/or other data) which, when accessed, results in a machine (e.g., the processor 387) performing such actions as prohibiting program execution from entering into a location of a kernel mode physical memory partition from a location outside the kernel mode physical memory partition unless the kernel mode physical memory partition location includes an entry instruction.

Other activities may include elevating a current privilege level to a privilege level associated with the kernel mode physical memory partition responsive to executing the entry instruction, as well as reducing the current privilege level to a lower privilege level than that associated with the kernel mode physical memory partition, responsive to continuing the program execution outside the kernel mode physical memory partition. Further activities may include permitting access by code included in the kernel mode physical memory partition to any location in the kernel mode physical memory partition, as well as permitting access to any memory location in a computer including the kernel mode physical memory partition by code included in the kernel mode physical memory partition.

Implementing the apparatus, systems, and methods described herein may result in improved security for instructions and data contained in kernel memory partitions. The combination of location-derived access privilege for instructions in a partitioned address space, and instructions whose location signifies legal points at which code in a higher-privileged partition can be entered from a lower-privileged partition, may also provide a completely new array of potential operational modes for a variety of processor architectures.

The accompanying drawings that form a part hereof show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A method, including:
prohibiting program execution from entering into a location of a physical memory partition from a location outside the physical memory partition unless the location of the physical memory partition includes an entry instruction.

2. The method of claim 1, further including:
designating the physical memory partition.

3. The method of claim 1, fuirther including:
elevating a current privilege level to a privilege level associated with the physical memory partition responsive to executing the entry instruction.

4. The method of claim 3, further including:
reducing the current privilege level to a lower privilege level than the privilege level associated with the physical memory partition responsive to the program execution leaving the physical memory partition.

5. The method of claim 1, further including:
branching to an interrupt destination location in a physical memory partition by activating a hardware mechanism in response to interrupting the program execution outside the physical memory partition; and
altering the current privilege level to the privilege level of the physical memory partition.

6. The method of claim 5, further including:
prohibiting branching to the interrupt destination location when initiated via executing an instruction not associated with a software interrupt.

7. The method of claim 1, further including:
permitting access by code included in the physical memory partition to any location in the physical memory partition.

8. The method of claim 1, further including:
permitting access by code included in the physical memory partition to a memory location included in another physical memory partition in a computer.

9. The method of claim 1, wherein the other physical memory partition is associated with a privilege level equal to or lower than a privilege level associated with the physical memory partition.

10. The method of claim 1, further including:
generating a fault responsive to detecting an attempt to continue the program execution into the location if the location of the physical memory partition does not include the entry instruction.

11. The method of claim 1, further including:
resetting a computer including the physical memory partition, responsive to detecting an attempt to continue the program execution into the location of the physical memory partition if the location of the physical memory partition does not include the entry instruction.

12. The method of claim 1, where the physical memory partition comprises a kernel mode physical memory partition.

13. An article including a machine-accessible medium having associated information, wherein the information, when accessed, results in a machine performing:
prohibiting program execution from entering into a location of a physical memory partition from a location outside the physical memory partition unless the location of the physical memory partition includes an entry instruction.

14. The article of claim 13, wherein the information, when accessed, results in a machine performing:
elevating a current privilege level to a privilege level associated with the physical memory partition responsive to executing the entry instruction.

15. The article of claim 13, wherein the information, when accessed, results in a machine performing:
reducing the current privilege level to a lower privilege level than the privilege level associated with the physical memory partition responsive to continuing the program execution outside the physical memory partition.

16. The article of claim 13, wherein the information, when accessed, results in a machine performing:
permitting access by code included in the physical memory partition to any location in the physical memory partition.

17. The article of claim 13, wherein the information, when accessed, results in a machine performing:
permitting access to any memory location in a computer including the physical memory partition by code included in the physical memory partition.

18. The article of claim 13, wherein the information, when accessed, results in a machine performing:
prohibiting access by code not included in the physical memory partition to any location in the physical memory partition.

19. The article of claim 13, where the physical memory partition comprises a kernel mode physical memory partition.

20. An apparatus, including:
a processor to designate a physical memory partition prohibiting program execution from entering into a location of the physical memory partition from a location outside the physical memory partition unless the location of the physical memory partition includes an entry instruction; and
a memory structure to include the physical memory partition.

21. The apparatus of claim 20, further including:
a privilege elevation module to elevate a current privilege level to a privilege level associated with the physical memory partition responsive to executing the entry instruction.

22. The apparatus of claim 20, further including:
a privilege elevation module to elevate a current privilege level to a privilege level associated with the physical memory partition responsive to receiving an interrupt.

23. The apparatus of claim 22, wherein the interrupt comprises a software interrupt.

24. The apparatus of claim 20, further including:
a privilege reduction module to reduce a current privilege level to a lower privilege level than a privilege level associated with the physical memory partition responsive to the program execution progress leaving the physical memory partition.

25. A system, including:
a solid state display;
a processor to couple to the display; and
a memory structure to couple to the processor and to include a physical memory partition designated by the processor to prohibit program execution from entering into a location of the physical memory partition from a location outside the physical memory partition unless the location of the physical memory partition includes an entry instruction.

26. The system of claim 25, further including:
an interrupt module to couple to the processor and to receive an interrupt; and
a privilege elevation module to couple to the interrupt module and to elevate a current privilege level to a privilege level associated with the physical memory partition responsive to receiving the interrupt.

27. The system of claim 26, wherein the interrupt comprises a hardware interrupt.

28. The system of claim 25, wherein the memory structure further includes:
at least two physical memory partitions with different associated privilege levels, including the physical memory partition.

29. The system of claim 25, wherein the processor comprises an Intel® XScale® processor.
